(19) United States
(12) Patent Application Publication
(10) Pub. No.: US 2003/0122970 A1
(43) Pub. Date: Jul. 3, 2003

(54) Digital broadcasting receiver

(76) Inventor: Takaya Nonomura, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/327,854

(22) Filed: Dec. 26, 2002

(30) Foreign Application Priority Data
Dec. 28, 2001 (JP) 398870/2001

(51) Int. Cl. H04N 5/38

(52) U.S. Cl. 348/723

(57) ABSTRACT

If a digital broadcasting receiver is installed in a kitchen, for example, a user uses a remote control transmitter, to display an installation place setting screen on a monitor and select “kitchen”. When such selection is performed, information related to the place of installation is stored in a nonvolatile memory. Conditions (keywords) such as “housewife” and “cooking” are registered with respect to the place of installation “kitchen”, and a CPU carries out control so as to select programs satisfying such conditions.

### BACKGROUND OF THE INVENTION

### FIELD OF THE INVENTION

The present invention relates to a digital broadcasting receiver that receives digital broadcasting.

A digital broadcasting receiver that receives digital broadcasting using a satellite or a terrestrial wave selects any of a plurality of broadcasting waves received through a dedicated antenna or a terrestrial wave antenna using a tuner, selects any of a plurality of channels included in the selected broadcasting wave using demultiplex processing, extracts a digital signal on the selected channel, and decodes the extracted digital signal, to output a video/audio signal.

In such digital broadcasting, program information is also transmitted besides transmitting video or audio, as in conventional analog broadcasting. The program information includes various types of information such as the name of a program, the time when the program begins, information related to the contents of the program, and information related to the genre of the program. It is possible to select a program desired by a user from multichannel broadcasting by an EPG (Electronic Program Guide) display function using an OSD (On-Screen Display) function on the side of the receiver.

Meanwhile, various types of information can be put on a digital broadcasting wave, as described above. Assuming that a regional commercial (CM) and an emergency broadcast, for example, are transmitted, therefore, regional information is previously set in receivers, thereby making it possible for only the receivers, installed in a certain region, to receive the regional commercial and the emergency broadcast. It is desired that the digital broadcasting receiver can further individually select the information by making use of the characteristics of the digital broadcasting wave.

### SUMMARY OF THE INVENTION

In view of the foregoing circumstances, an object of the present invention is to provide a digital broadcasting receiver capable of selecting suitable information for the place of viewing.

In order to solve the above-mentioned problem, a digital broadcasting receiver according to the present invention is characterized by comprising receiving means for receiving a digital broadcasting wave; means for setting information related to the place of installation; and control means for selecting a broadcasting wave on the basis of the information related to the place of installation and/or selecting information included in the received broadcasting wave.

In the above-mentioned configuration, the selection of the broadcasting wave corresponding to the place of installation of the digital broadcasting receiver and/or the selection of the information included in the received broadcasting wave can be made. Therefore, suitable information for the place of viewing can be presented to a user.

The digital broadcasting receiver may further comprise means for taking out program information from the digital broadcasting wave, to select a program on the basis of the information related to the place of installation and the program information.

When “child's room” is previously set as the place of installation, programs for children, for example, can be mainly received.

The digital broadcasting receiver may be so configured that the program information is retrieved on the basis of the information related to the place of installation to present the results of the retrieval.

Consequently, the function of retrieving the place of installation can be provided, similarly to the function of retrieving the genre, for example.

The digital broadcasting receiver may be so configured that in a case where an instruction to change a channel is issued by a user, it is judged whether or not the change in the channel is appropriate on the basis of program information on the channel and the information related to the place of installation, to perform, when it is judged that the change in the channel is not appropriate, stop of video output or processing for not changing the channel or automatic change into an appropriate channel.

In a case where the place of installation is “child's room”, when a program for adults is selected by changing the channel; for example, therefore, the video output is stopped, the processing for not changing the channel is performed, and the automatic change into the appropriate channel is performed.

The digital broadcasting receiver may be so configured that a keyword corresponding to the information related to the place of installation is stored, to perform positive selection or avoidable selection of a program corresponding to the keyword.

In such a configuration, in a case where information indicating “there are scenes of violence” exists in the details of the program in the program information, and the place of installation is “child's room”, when the above-mentioned program is selected, the avoidable selection (the stop of the video output, the processing for not changing the channel, the processing for automatic change into the appropriate channel, described above, etc.) is performed if “violence” is registered as an avoidable keyword. On the other hand, in a case where information indicating “there are scenes of friendship” exists in the details of the program in the program information, and the place of installation is “child's room”, when the above-mentioned program is selected, the positive selection is performed.

The digital broadcasting receiver may be so configured that advertisement information is selected on the basis of the information related to the place of installation.

In a case where advertisement information “suits” and advertisement information “toys”, for example, are put on the broadcasting wave, when the place of installation is “child's room”, the advertisement information “toys” is selected and presented.

The digital broadcasting receiver may be so configured that a keyword corresponding to the information related to the place of installation is stored, to select the advertisement information corresponding to the keyword.

The digital broadcasting receiver may be so configured that entry of a personal identification number is a requirement for changing the information related to the place of installation.

Consequently, an infant can be prevented from changing the setting of the place of installation of the receiver without permission while a guardian is absent, for example.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a digital broadcasting receiver 30 according to the present embodiment;

FIG. 2 is an explanatory view of an installation place setting screen; and

FIG. 3 is an explanatory view of a screen showing in tabular form retrieval conditions (keywords) in a case where the place of installation is “hospital's waiting room”.

### DESCRIPTION OF THE PREFERRED EMBODIMENTS

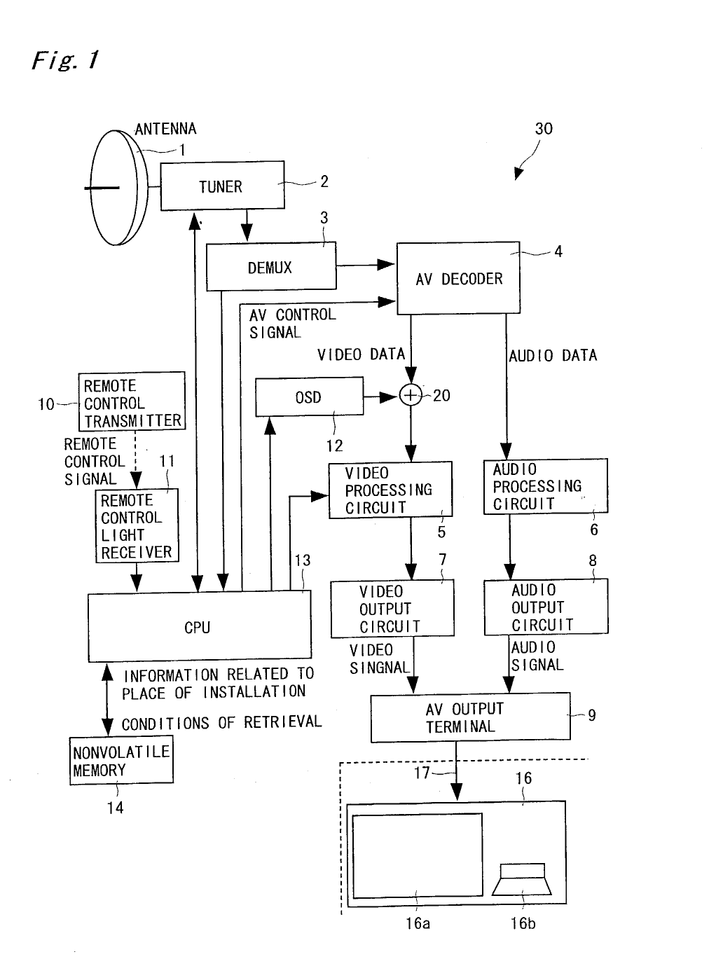

An embodiment of the present invention will be described on the basis of FIGS. 1 to 3. Here, a case where a user views BS (Broadcasting Satellite) digital broadcasting is illustrated.

An antenna 1 is arranged in a predetermined direction outdoors, and receives a digital broadcasting signal fed from a BS. The antenna 1 generally comprises a frequency converter, and feeds a received/frequency-converted signal to a tuner 2.

The tuner 2 extracts, out of high-frequency digital modulation signals including video/audio data, the signal having a particular frequency. That is, it performs processing for selecting one of a plurality of transponders for digital broadcasting. Further, the tuner 2 comprises a demodulation circuit, an inverse interleave circuit, an error correcting circuit, and so on, thereby demodulating the selected digital modulation signal and outputting a transport stream.

A demultiplexer (DEMUX) 3 separates the transport stream into a video stream and an audio stream based on MPEG2 (Moving Picture Experts Group2) and PSI/SI (Program Specific Information/Service Information). The demultiplexer 3 feeds the video stream and the audio stream to an AV decoder 4, and feeds to a CPU 13 program information (the name of a program, the time when the program begins, information related to the contents of the program, information related to the genre of the program, the parental level, etc.), for example, included in the PSI/SI. As described above, a plurality of channels are multiplexed on the transport stream. Processing for selecting any of the channels can be performed by taking out from the above-mentioned PSI/SI data indicating which packet ID in the transport stream is used to multiplex the arbitrary channel. Further, not only a main channel but also a subchannel is multiplexed on a digital broadcasting wave. When a DEMUX control signal is fed to the demultiplexer 3 from the CPU 13 such that the subchannel is selected, information on the subchannel is outputted. Further, data broadcasting for providing a still image, character information, and audio information is multiplexed on the digital broadcasting wave. In the broadcasting, advertisement information (CM) is inserted everywhere. Advertisement information other than the advertisement information can be inserted into the subchannel or the data broadcasting. of course, a channel specializing in the advertisement information can be also provided. It is possible to insert into the digital broadcasting wave information indicating on which subchannel, for example, the advertisement information exists and information indicating in which place of installation the advertisement information is suitable.

The AV decoder 4 comprises a video decoder for decoding the video stream and an audio decoder for decoding the audio stream. The video decoder decodes a variable length code which has been inputted, to find a quantization factor and a motion vector, thereby carrying out inverse DCT (Discrete Cosine Transformation), motion compensation control based on the motion vector, and the like. The audio decoder decodes a coded signal which has been inputted, to produce audio data. The video data produced by the decoding is outputted to a video processing circuit 5, and the audio data is outputted to the audio processing circuit 6.

The video processing circuit 5 receives the video data from the AV decoder 4 and subjects the received video data to digital-to-analog (D/A) conversion, to convert the video data into a composite video signal, for example. The audio processing circuit 6 receives the audio data outputted from the AV decoder 4 and subjects the received audio data to digital-to-analog (D/A) conversion, to generate an analog signal of a right (R) sound and an analog signal of a left (L) sound, for example.

Each of a video output circuit 7 and an audio output circuit 8 comprises an output resistor, an amplifier, and so on. An AV output terminal 9 is provided with an output unit (a set of a right/left audio output terminal or the like and a video output terminal or the like). A monitor 16 comprising a CRT (Cathode Ray Tube) 16a and a speaker 16b is connected to the output unit by a video/audio code 17.

An OSD (On-Screen Display) circuit 12 outputs to an adder 20 bit map data based on character information or color information which it is instructed to output from the CPU 13. The adder 20 performs processing for incorporating the bit map data into the received video data outputted from the AV decoder 4. By the OSD circuit 12, display of an EPG (Electronic Program Guide) based on the above-mentioned program information received by the CPU 13, for example, can be performed.

A remote control transmitter 10 is a transmitter for sending out a command to the broadcasting receiver 30. When a key (not shown) provided in the remote control transmitter 10 is operated, signal light (a remote control signal) meaning a command corresponding to the key is sent out from a light emitter (not shown) . A remote control light receiver 11 receives the signal light, converts the received signal light into an electric signal, and feeds the electric signal to the CPU 13. A user can perform various types of setting on a setting screen using an “up-and-down” key, a “enter” key, etc. provided in the remote control transmitter 10.

A nonvolatile memory (e.g., an EEPROM (Electrically Erasable And Programmable ROM) ) 14 stores information related to the place of installation, etc. in addition to data (program information) for displaying an EPG screen.

Although the CPU 13 carries out overall control in the digital broadcasting receiver 30, it makes selection of a broadcasting wave based on the information related to the place of installation and/or selection of information included in the received broadcasting wave. Description is now made of such selection control.

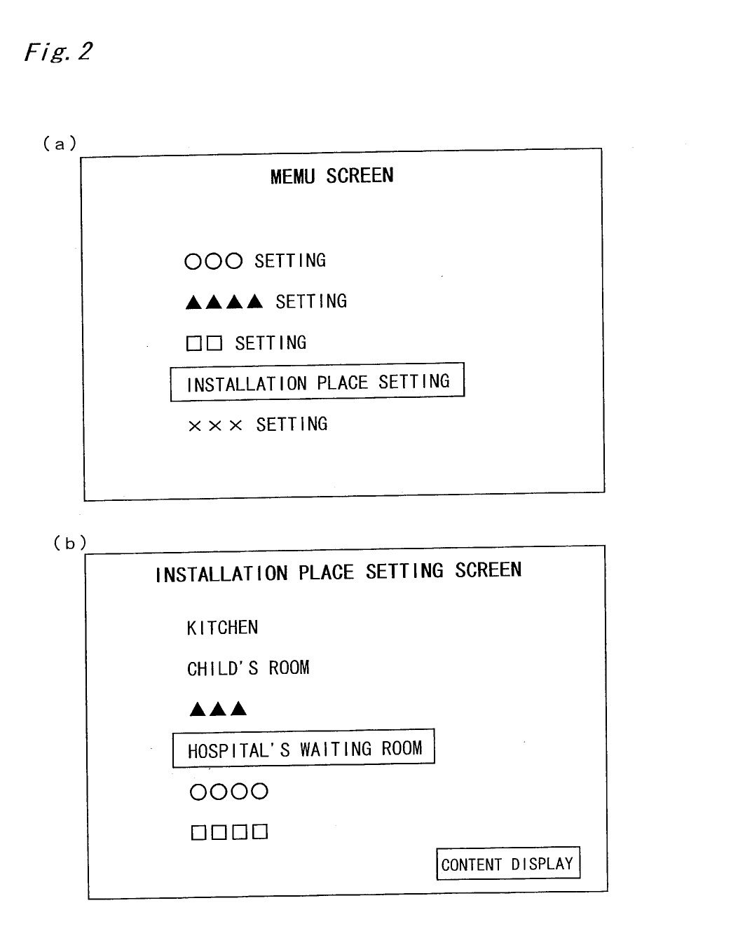

FIG. 2 (a) is an explanatory view of a menu screen for selecting various types of setting in the receiver, and FIG. 2 (b) is an explanatory view of an installation place setting screen for setting the place of installation. On the menu screen shown in FIG. 2 (a), when the user uses the “up-and-down” key provided in the remote control transmitter 10 to select (change the color of) an item “installation place setting”, and presses the “enter” key, the installation place setting screen shown in FIG. 2 (b) can be displayed. On the installation place setting screen, choices such as “kitchen”, “child's room”, and “hospital's waiting room”, for example, are provided. The user can set the place of installation of the receiver by selecting, out of the items, the item corresponding to the place of installation using the remote control transmitter 10.

In each of the places of installation, positive conditions for specifying a program which is desired to be received by the receiver and receiving restriction conditions for specifying a program whose receiving is conversely restricted are previously set. In order for the user to confirm the contents of the conditions related to each of the places of installation, the place of installation whose contents are desired to be confirmed may be selected on the installation place setting screen shown in FIG. 2 (b), to operate a “content display” button provided on a lower part of the screen, for example.

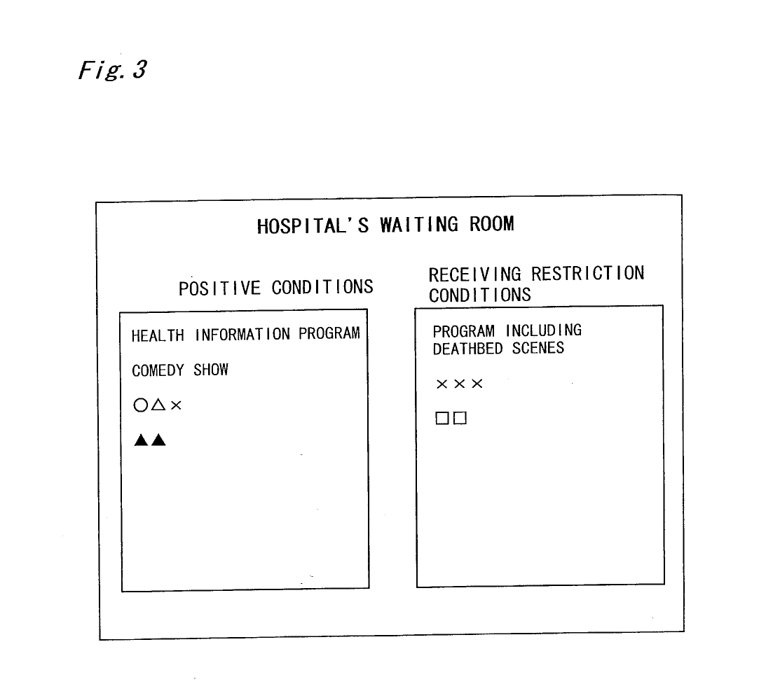

FIG. 3 is a screen in a case where “hospital's waiting room” is selected to request the display of the contents thereof, and shows in tabular form conditions (keywords) corresponding to the place of installation. As the positive conditions for specifying a program which is desired to be received, “health information program”, “comedy show”, etc. are set. On the other hand, as the receiving restriction conditions for specifying a program whose receiving is restricted, “program including deathbed scenes”, etc. are set. The CPU 13 can retrieve the program information using the conditions and select the program and the advertise information.

Furthermore, on the installation place setting screen, the user may be requested to register a personal identification number in registering the place of installation. In order to change the place of installation set once, the CPU 13 requests the user to enter the personal identification number so that the place of installation cannot be changed unless the same personal identification number as the personal identification number previously registered is entered. Consequently, an infant can be prevented from changing the setting of the place of installation of the receiver without permission while a guardian is absent, for example.

On the installation place setting screen shown in FIG. 2 (b) , in a case where the user previously sets “hospital's waiting room” as the place of installation in the above-mentioned method, when the power to the digital broadcasting receiver is turned on, the CPU 13 reads out the conditions (keywords) corresponding to “hospital's waiting room” from the nonvolatile memory 14. The CPU 13 performs processing for retrieving genre information and detailed program information in the program information on the basis of the positive conditions such as “health information program” and “comedy show” and the receiving restriction conditions such as “program including deathbed scenes”, shown in FIG. 3, and receiving the corresponding program. On the side of a broadcasting enterpriser, the information (keyword) which easily fits the above-mentioned conditions on the side of the receiver may be positively added as the detailed program information. On the other hand, also with respect to the advertisement information, the CPU 13 may give priority to and select, out of the received advertisement information, the information related to “health” or the information “laughing”, for example. Also in this case, on the side of the broadcasting enterpriser, the information which easily fits the above-mentioned conditions on the side of the receiver may be added as attribute information related to the advertisement information.

On the installation place setting screen shown in FIG. 2 (b) , in a case where “kitchen” is set as the place of installation, when the user performs the operation for turning on the power or selects an installation place receiving mode, for example, the CPU 13 reads out conditions corresponding to the place of installation “kitchen” from the nonvolatile memory 14 When the place of installation is “kitchen”, “cooking” and “program for housewives”, etc. are considered as the positive conditions. The CPU 13 uses the positive conditions to perform processing for retrieving program information and receiving a program corresponding to “kitchen”. On the other hand, with respect to the advertisement information, the CPU 13 gives priority to and selects, out of the received advertisement information, the information handling food or kitchenware. Here, assuming that advertisement information related to food exists on the subchannel, for example, it is possible to automatically switch, when broadcasting is switched from the program to normal advertisement (a commercial) on the main channel, the main channel to the subchannel to display the advertisement information related to food. Further, it is also possible to previously acquire and store advertisement information from data broadcasting handling food or kitchenware and automatically display the stored advertisement information when broadcasting is switched from the program to the normal advertisement on the main channel. Alternatively, it is also possible to perform processing for displaying the normal advertisement on the main channel as well as superimposing the stored advertisement information related to food or kitchenware using the OSD circuit 12.

Furthermore, on the installation place setting screen shown in FIG. 2 (b), in a case where “child's room” is set as the place of installation, when the user performs the operation for turning on the power, for example, the CPU 13 reads out conditions corresponding to the place of installation “child's room” from the nonvolatile memory 14. When out of the conditions, the positive conditions are “program for children” and “recommendable program for elementary students”, and the receiving restriction conditions are “program including scenes of violence”, for example, the CPU 13 uses the conditions to perform processing for retrieving program information and receiving a program corresponding to the child's room. When the place of installation is “child's room”, the viewing of the program may be restricted using the parental level of the program in addition to retrieval of the contents of the program and the genre information. Further, with respect to the commercial, the CPU 13 gives priority to and selects, out of the received advertisement information, the information handling toys.

When an instruction to change a channel is issued by the user, the CPU 13 may judge whether or not the change in the channel is appropriate on the basis of program information on the channel and information related to the place of installation, to stop video output or perform processing for not changing the channel when it is judged that the change in the channel is not appropriate. In a case where the place of installation is “child's room”, when a channel (program) on which “scenes of violence” exist is selected, the video output is stopped, or the processing for not changing the channel is performed. In a case where a plurality of programs corresponding to the positive conditions are broadcast, the other program corresponding to the positive conditions may be automatically selected.

The program information may be retrieved to present the results of the retrieval on the basis of the information related to the place of installation. Consequently, the function of retrieving the place of installation can be provided to the user, similarly to the function of retrieving the genre, for example.

Attribute information such as “for kitchen”, “for child's room”, or “for hospital's waiting room” and further, a score representing the degree are added to the broadcasting program or the advertisement information on the side of the broadcasting enterpriser, so that the program and the advertisement information can be selected on the basis of the attribute information and the score without conditions (keywords) on the side of the receiver.

The positive conditions and the restriction conditions (keywords) for the place of installation information in the receiver may be previously set on the side of a manufacturer, or may be added and deleted on the side of the user.

As described in the foregoing, in the digital broadcasting receiver according to the present invention, the place of installation can be set for each receiver. Accordingly, broadcasting corresponding to the place of installation can be received to display video. Consequently, the effect of providing for the user a program and advertisement information which conform to the place of viewing is produced.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A digital broadcasting receiver comprising:
receiving means for receiving a digital broadcasting wave;
means for setting information related to the place of installation; and
control means for selecting a broadcasting wave on the basis of said information related to the place of installation and/or selecting information included in the received broadcasting wave.

2. The digital broadcasting receiver according to claim 1, further comprising
means for taking out program information from the digital broadcasting wave,
a program being selected on the basis of said information related to the place of installation and said program information.

3. The digital broadcasting receiver according to claim 2, wherein
the program information is retrieved on the basis of the information related to the place of installation to present the results of the retrieval.

4. The digital broadcasting receiver according to claim 2, wherein
in a case where an instruction to change a channel is issued by a user, it is judged whether or not the change in the channel is appropriate on the basis of program information on the channel and the information related to the place of installation, to perform, when it is judged that the change in the channel is not appropriate, stop of video output or processing for not changing the channel or automatic change into an appropriate channel.

5. The digital broadcasting receiver according to claim 2, wherein
a keyword corresponding to said information related to the place of installation is stored, to perform positive selection or avoidable selection of a program corresponding to the keyword.

6. The digital broadcasting receiver according to claim 1, wherein
advertisement information is selected on the basis of said information related to the place of installation.

7. The digital broadcasting receiver according to claim 2, wherein
advertisement information is selected on the basis of said information related to the place of installation.

8. The digital broadcasting receiver according to claim 6, wherein
a keyword corresponding to said information related to the place of installation is stored, to select the advertisement information corresponding to the keyword.

9. The digital broadcasting receiver according to claim 7, wherein
a keyword corresponding to said information related to the place of installation is stored, to select the advertisement information corresponding to the keyword.

10. The digital broadcasting receiver according to claim 1, wherein
entry of a personal identification number is a requirement for changing said information related to the place of installation.

11. The digital broadcasting receiver according to claim 2, wherein
entry of a personal identification number is a requirement for changing said information related to the place of installation.
